(19) United States
(12) Patent Application Publication
(10) Pub. No.: US 2010/0075830 A1
(43) Pub. Date: Mar. 25, 2010

(54) Activated carbon separation and reuse

(76) Inventors: Jiann-Yang Hwang, Chassell, MI (US); Xiaodi Huang, Houghton, MI (US); Richard Kauppila, Negaunee, MI (US)

Correspondence Address: Jiann-Yang Hwang, 44418 Old 41 Rd., Chassell, MI, 49916, US

(21) Appl. No.: 12/586,263

(22) Filed: Sep. 17, 2009

Related U.S. Application Data
(60) Provisional application No. 61/194,027, filed on Sep. 23, 2008.

(51) Int. Cl. B01J 20/34

(52) U.S. Cl. 502/56

(57) ABSTRACT

A method of treating spent sorbent from power plants containing materials including mercury absorbed from emission gases comprising putting said spent sorbent in an atmosphere isolated container or furnace chamber and heating said sorbent by microwave, radio frequency and/or infrared irradiation. The sorbent is heated to a temperature of at least the boiling point of the major contaminant, including mercury. No air or purge gas is added except to maintain safe pressure conditions, to control combustion of the sorbent and increase efficiency. The resulting vapor is released through an exhaust port of the chamber that leads to a condenser where mercury is condensed and separated. Other residual vapors are led to a scrubber for further cleansing and may be returned to the power plant for other applications. The hot treated sorbent is cooled down prior to contacting with air for later reuse in the power plant.

### CROSS-REFERENCE TO RELATED APPLICATIONS

This application claims the benefit under 35 U.S.C. 119(e) of U.S. Provisional Application No. 61/194,027 filed Sep. 23, 2008, the disclosure of which is hereby incorporated by reference in its entirety.

### BACKGROUND OF THE INVENTION

Mercury exists naturally in any of three valence states: Hg⁰, Hg₂²⁺, and Hg²⁺. All chemical forms of mercury are known as human health hazards. A major source of mercury is from the emission gases of combustion operations. Combustible materials like coal, garbage, hospital wastes and others usually contain a trace amount of mercury. Due to the low boiling temperature of elemental mercury and its compounds such as mercury chlorides and mercury sulfides, mercury ends up in the emission gases. Mercury can also be present in the wastewater from the mining, dental, and other operations. Regulations from governments include the removal of mercury from emission gases and water to protect all living creatures and the environment.

Mercury removal from the emission gases or water is both difficult and expensive. The mercury concentration can be very low, expressed in ppb units, and to remove this trace amount of mercury requires the treatment of a large amount of the contaminated gas or water. Mercury removal from emission gases and water can be achieved with sorbents of carbonaceous, mineral, and polymeric based materials such as activated carbon, charcoal, charred carbon, bromine treated carbon, bicarbonate treated carbon, modified Hardwickia binata bark, zeolite, montmorrilonite, bentonite, ash minerals, polymers and their derivatives loaded with mercury affinity functional groups such as sulfides, carboxyls, amines, phosphates, halides, oxidants, and others. Emission gases of combustion operations are made to pass an adsorber chamber or column containing a sorbent where contaminants are adsorbed prior to releasing the gas to the atmosphere. In some cases, coarse fly ash is first filtered out from the emission gases before the gas passes the adsorbing chamber. In other cases, the fly ash is adsorbed together with the other contaminants. After the sorbents are saturated with the contaminants or used up, one should avoid the disposal of the sorbent since it is loaded with mercury. Its disposal will result in the pollution of the environment again. It is desired to recycle the sorbents by removing mercury from the sorbents and reuse the sorbents due to the high cost of the sorbent. It is also desired to remove the mercury from the sorbents, condense and collect it so that the mercury can be isolated from the environment under controlled conditions or can be reused. This invention addresses these issues and presents a very cost effective and novel means of treating and recovering sorbent.

### BACKGROUND

The following are deemed to be the most relevant reference on the subject matter:
Jiann-Yang Hwang et al of Michigan Tech (U.S. Pat. No. 6,027,551 [2000]) disclosed the separation of fly ash carbon and the removal of mercury from fly ash carbon with a heating process using air or nitrogen gas.
Bruce Ramme et al of Wisconsin Electric (U.S. Pat. No. 7,217,401 [2007]) disclosed the removal of mercury from activated carbon sorbent and fly ash using heated flowing air as heat source for the sorbent and as purging gas for the gasified components.
Tranquilla (U.S. Pat. No. 7,214,254 [2007]) disclosed the removal of mercury from contaminated materials by mixing the contaminated material with a constant stream of hot gas in a fluidized bed reactor while applying microwave. A host bed of inert microwave receptive material is also added to make a mixture that supposedly allows for operation at a significantly higher temperature to combust carbon from fly ash or for carbon-rich sorbents, to prevent its clinkering.
Kotsch et al. (U.S. Pat. No. 4,737,610 [1988]) disclosed a method and apparatus for desorbing a granular carbonaceous sorbent contaminated with sulfur oxides and chlorides using radiation/microwave. Inert gases are introduced as circulating medium for transporting desorbed noxious gases out of a reactor, and so directed as to prevent escape of desorbed gases from the reactor. Part of it is purged out with the noxious gases and part it sent back to the reactor to further circulate with the desorbed gases. Some more inert gases are introduced for helping cool the cooling chamber for treated sorbent.
Mezey et al (U.S. Pat. No. 4,322,394 [1982]) disclosed a method of desorbing contaminated adsorbate right within the adsorbing chamber of the flue gas stream using microwave heating and using a limited amount of inert gas like nitrogen for purging out the gasified contaminants. The in-place desorbing process supposedly prevents attrition and mechanical degradation of the adsorbate that would otherwise result from transferring to another location for further regeneration treatment.
Weyand et al (U.S. Pat. No. 7,048,779, [2006]) disclosed a method of removing Hg from fly ash free contaminated powdered activated carbon adsorbed from a fly-ash free filtered exhaust gas in a coal fired power plant at elevated temperatures of 300-500 C and in the presence of inert gases like nitrogen, argon, helium and others.
Woodmansee et al (U.S. Pat. No. 5,411,712, [1995]) patented a batch method for desorbing successive batches of contaminated adsorbent using microwave. Inert gases are used to purge the gasified contaminant into a gas processing unit for further treatment.

In all cases, even without the need for fluidizing the layer of sorbent in the furnace nor the use of hot inert gas or air to heat the sorbent, there is always the addition of a purging gas to direct the gasified contaminants out of the heating chamber and towards the place of further treatment. All experimental data presented in the disclosures of the above references are based on the use of inert gas like nitrogen but the patent claims of some of these disclosures have air as the purging gas used. As a result, the commercial viability of the experimental results can be questioned. The issue of combustion and resulting loss of carbon-based sorbents when exposed to hot air is a well known concern in the art yet these disclosures circumvented finding a solution to the problem by simply using Nitrogen during experimentation. In real applications, the loss of use of combusted sorbents could outweigh the benefits of the proposed method of sorbent treatment.

In a laboratory experiment, Mesey et al (U.S. Pat. No. 4,322,394) used a purge gas rate of 0.5 ft cube/min. for 10 minutes for a 2½″ diameter and 4″ deep cylindrical adsorber column. Commercial adsorbers can range from 3-12′ dia and 3-20′ deep. Therefore, the cost to heat the gas in any experiment must be multiplied several thousand times over to get an idea of the real cost requirements in commercial applications. The operating cost and fixed cost include cost of steady source of inert gas supply, energy to heat the gas, instrumentation, and valving and piping to supply the gas, provision and maintenance of a larger furnace, condenser, and scrubber to accommodate the treatment of the added gas volume.

### OBJECTS AND ADVANTAGES

Mercury desorption from a sorbent can be achieved at temperatures at least at the boiling point of mercury which is 356° C. As prior art show, the heating can be accomplished through a number of means—hot gas, dielectric, ohmic, radiation, microwave, etc. No matter what the heat source is, prior art has not dealt away with the addition of gases to the system either as means to deliver heat to the sorbent, or to fluidize/stir a bed of sorbent, or simply to purge the volatilized components out of the furnace.

We found that a major obstacle in the sorbent recycling and mercury separation, condensation, and collection operations is in the area of avoiding large volumes of gases in the system. The addition of gas, regardless of whether it is inert nitrogen or ambient air, dilutes the volatilized contaminants, rendering it more costly to process downstream. More significantly, the added gas has to be heated separately prior to use lest it condenses the already volatilized contaminants while still in the furnace, thus defeating the purpose of the operation. Microwave cannot be used to heat the gas along with the sorbent because gas is not dielectric. Additionally, since the hot, evaporated mercury has to be cooled down, condensed, and collected, it is necessary to keep the gasified components from being unnecessarily diluted. The cool down is usually accomplished with a heat exchanger. Too much gas in the system will require more heat exchange and this will make the mercury condensation difficult and energy inefficient. In addition, if air or other oxidant is allowed in the system, it could cause the oxidation or combustion of carbonaceous and polymeric sorbents. This is to be avoided since this will cause the loss of the sorbent material. Heating under inert gases such as nitrogen can avoid the oxidation, but the gas cost is high. Using a non-carbon based sorbent may eliminate the concern over oxidation caused by the presence of air but such sorbents are generally more costly and less effective.

In addition to teaching the advantages of the use of microwave as a very cost efficient heat source for sorbent recovery, the present invention teaches the use of a vacuum downstream of the furnace in conjunction with the high pressure of the gasified contaminants to purge the gas out of the furnace to the condenser for further treatment. The present invention also teaches that uniform microwave exposure can be accomplished by mechanized or magnetic stirring and the use of continuous furnaces like rotary hearth, rotary kiln, traveling bed, and shaft furnaces. This method is effective in removing the gasified contaminants from the furnace even without fluidizing the bed and without using purging gases. Continuous sorbent treatment furnaces are especially desirable for use in power plants that also continuously generate contaminated exhaust gases from continuously operating combustion processes. A constant supply of sorbent must be made available for use. The continuous processes disclosed in this present invention addresses that need. The machinery presented is made simpler and more cost efficient by the elimination of purging and heating gases in the design. Satisfying the electrical requirements of a vacuum in a commercial application will be less costly than the operating and fixed costs associated with the provisions for purging gas including a steady supply of the purging gas, heating said gas, valving, piping, a larger furnace, condenser, scrubber and others.

### SUMMARY

In accordance with the present invention a sorbent recovery system comprises feeding a spent sorbent containing materials absorbed from emission gases in power plants in an atmosphere isolated container or furnace chamber and heating said sorbent by microwave, radio frequency, infrared irradiation and/or induction heating. The sorbent is heated to a temperature at least at the boiling point of mercury, a major contaminant in the sorbent. No air or any other gas is added to control combustion of the sorbent and increase efficiency. The resulting vapor is released through an exhaust port in the container or chamber that leads to a condenser where mercury is condensed and separated. Other residual vapors are led to a scrubber for further cleansing and may be returned to the power plant for combustion and/or mercury adsorption. The hot treated sorbent is cooled down prior to contacting with air for later reuse in the power plant. Several continuous operating furnaces embodying the present invention are presented.

### DESCRIPTION OF DRAWINGS

FIG. 1 shows a conceptual flow chart of a sorbent recovery system of the present invention using an electromagnetic or induction furnace as the heating chamber.

FIG. 2 shows a top view of a continuous microwave rotary hearth furnace.

FIG. 3 shows the rotary hearth furnace of FIG. 2 viewed along its perimeter starting from section A of FIG. 2.

FIG. 4 shows a continuous microwave traveling grate furnace.

FIG. 5 shows a continuous microwave rotary kiln furnace.

FIG. 6 shows a continuous microwave shaft furnace.

### DETAILED DESCRIPTION

This invention teaches a method to remove mercury from sorbents loaded with mercury by a microwave, radio frequency, infrared irradiation and/or induction heating method with minimum or no gas involved. The microwave, radio frequency, infra red, and induction heating technology offer different heating mechanisms from conventional heating. The microwave, radio frequency, and infra red waves are electromagnetic waves. Their absorption of the waves by materials results in heating of the material. Induction heating uses electrical resistivity of materials to generate heating. These methods do not need any gas media to transfer the heat and therefore, will not encounter the problems associated with the conventional heating.

When the sorbent is heated by the wave irradiation or the induction in an atmosphere isolated container or furnace chamber to an elevated temperature to evaporate mercury, the reaction between the sorbent and oxygen will be suppressed due to the short of oxygen supply. The mercury vapor exits through a pipe or an exhaust port connected to a mercury condenser where the mercury is condensed and collected.

A vacuum is introduced downstream of the furnace to pump the evaporated mercury and other gases out of the furnace, and direct it to the condenser.

Although it is preferred to treat the sorbents dry, water may be added to the sorbent prior to the treatment to avoid the dust. The amount of water added to the sorbent should be less than the sorbent weight and preferably be less than 20% of the moisture content.

The mercury evaporation by microwave, radio frequency and/or infrared irradiation can be carried out in batch or continuous operations. The devices to conduct the microwave, radio frequency and/or infrared heating may include continuous furnaces such as rotary hearth, rotary kiln, traveling grate/bed, conveyor belt, and paddle or screw driven material transportation unit and batch furnaces such as those similar to the common microwave ovens. Induction heating can be carried out with an induction heating furnace. All of these systems are air or gas tight, and microwave and radio frequency sealed up to 1,200° C. Particularly, the rotary hearth and rotary kiln furnaces have both dynamic air and wave seals on large diameter rotating contact surfaces. The air seal can ensure negative or positive chamber pressure needed at elevated operation temperatures. To prevent potential thermal distortion of the contact surfaces and thermal damage to air and wave sealants, the contact surfaces are water-cooled. All continuous furnaces may be installed with air-locked and wave sealed rotating valves for solid material charging and discharging. The walls and sorbent beds may preferably be made with microwave resistant materials so that the sorbent absorbs all or most of the microwave.

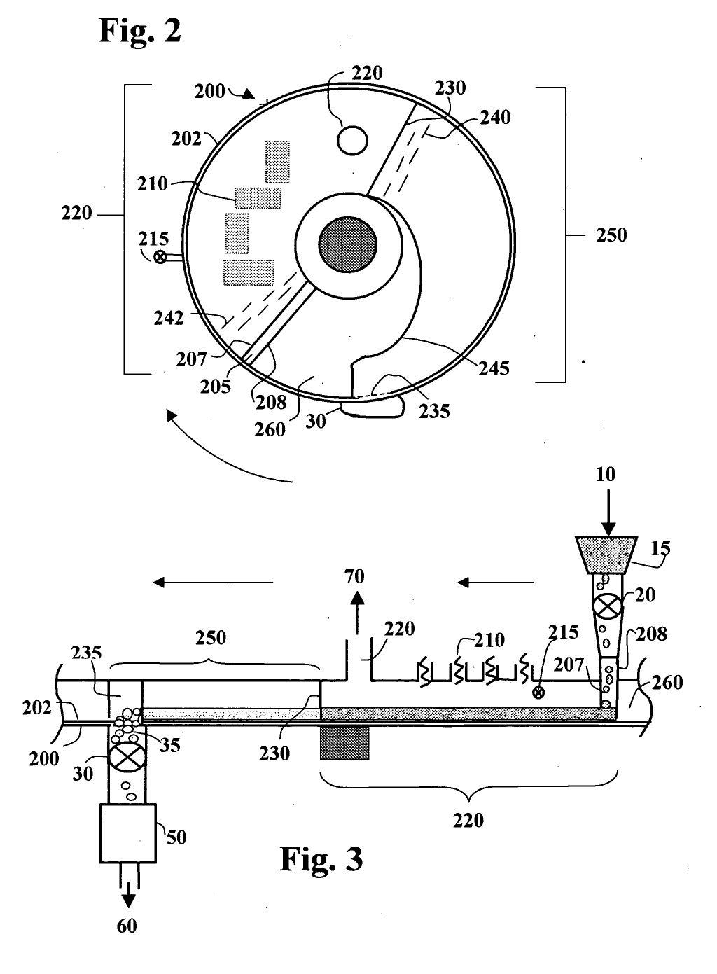

Examples of continuous furnace apparatus for metal production using microwave energy have been disclosed by the inventors Xiaodi Huang and Jiann-Yang Hwang (U.S. patent application Ser. No. 11/906,761). The disclosure is incorporated herein by reference. It can be appreciated that the present invention is importantly applicable to the adsorbate of the exhaust gas of said referenced metal production operation as well as for other combustion operations in other plants. FIGS. 2 through 6 show the present invention as applied to continuous furnace processes. The rotary hearth, rotary kiln, traveling bed, and the screw driven shaft furnaces using a continuous and microwave heating process are viable embodiments of the present invention.

While furnaces can be constructed to withstand high positive or negative pressures, minimal air entry may be allowed in the system possibly through a control valve. This is desirable especially for a continuous operation. The valve may be programmed to let air in to maintain the minimum allowed negative pressure. If the free cavity surrounding the sorbent inside the furnace is kept to a minimum, any possible combustion of the sorbent is kept in check. With programmable control valves along the exhaust line, atmospheric pressure conditions may be maintained inside the furnace at certain or all times as desired. Small amounts of CO₂, H₂0, or O₂, as may be derived from air introduced through air valve 107, can regenerate or rejuvenate the carbon surface and adsorbing properties of the sorbent.

The hot mercury-stripped sorbent needs to be cooled down preferably to below 200 C, before contacting air to avoid oxidation or combustion of the sorbent. This will be accomplished in a cooler with heat exchange connecting to the material discharging port.

A scrubber may be utilized to control the gas emissions after the condenser. The scrubber may have oxidants such as potassium permanganate in the water solution to extract mercury and other contaminants from the gas emissions. As an alternative, the emission gas may be returned to the power plant or other combustors/incinerators for combustion and/or mercury adsorption.

### Example

The following example is presented to provide basic understanding of the present invention. It is intended to be illustrative and no limitations to the present invention should be inferred from this example:

In each test, 30 grams of a mercury loaded sorbent containing activated carbon from a power plant (WE Energy's Presque Isle power station, Marquette, Mich.) was placed in a 1-kilowatt microwave oven. The oven is airtight except that an opening is provided at the top to collect the emission gas. The microwave time was set at 1 minute, 3 minutes, and 5 minutes. In each test, the sorbent was heated rapidly during the microwave irradiation. After the microwave is turned off, the carbon sorbent is cooled down and no combustion of the carbon was observed. The gas coming out from the top was condensed in a water cooled condenser. The mercury content in the sorbent before the microwave irradiation is 14,800 ppb. After 1, 3, and 5 minutes of microwave irradiation, the mercury content in the sorbent was reduced to 162, 306, and 173 ppb respectively, as shown in the Table 1 below. This clearly demonstrates that mercury can be effectively removed from the sorbents rapidly with microwave heating and the gasified contaminants driven out without the addition of purge gases. Condensed mercury can be observed in the condenser.

TABLE 1
Mercury concentration of sorbent before and after microwave
irradiation within minutes.

| | Test | | | |
|---|---|---|---|---|
| | Head | MW Test 1 | MW Test 2 | MW Test 3 |
| Hg conc. (ppb) | 14,800 | 162 | 306 | 173 |

For a sorbent recovery system, the following components may be included:
1) Sorbent material Receiving and Handling—The sorbent recovery apparatus may be situated proximal to the flue gas adsorbent chamber and sorbent collecting unit or bin of a combustion operation in order to minimize transport costs.
2) Feeder—This is preferably airlock to prevent entry of needless air and escape of gasified contaminants. The operation is well known in the art.
3) Microwave, radio frequency, infrared, or induction furnace—The standard components of these types of furnaces such as power source, microwave emitter, wavelength guide, furnace monitors, magnetic stirrers and the like are well known in the art so they need not be presented herein in detail and are omitted in the illustration. The shape of the furnace cavity may be designed with consideration of aerodynamic movements of the volatilized contaminants as they exit the chamber. The material of construction of its internal walls will preferably be non-microwave receptive.
4) Programmable or manual Monitors, Controllers, Instrumentation—To maintain desired temperature and pressure levels in the system, and to coordinate feed input, furnace residence time, and output for a smooth operation.
5) Mercury Vapor Transporting—the gasified contaminants are sucked out of the furnace chamber by vacuum and high pressure for further recovery treatment.
6) Mercury Condensing, Scrubbing, and Monitoring
7) Sorbent Cooling and Discharging—The cleaned sorbent is released through an airlock discharge and cooled.

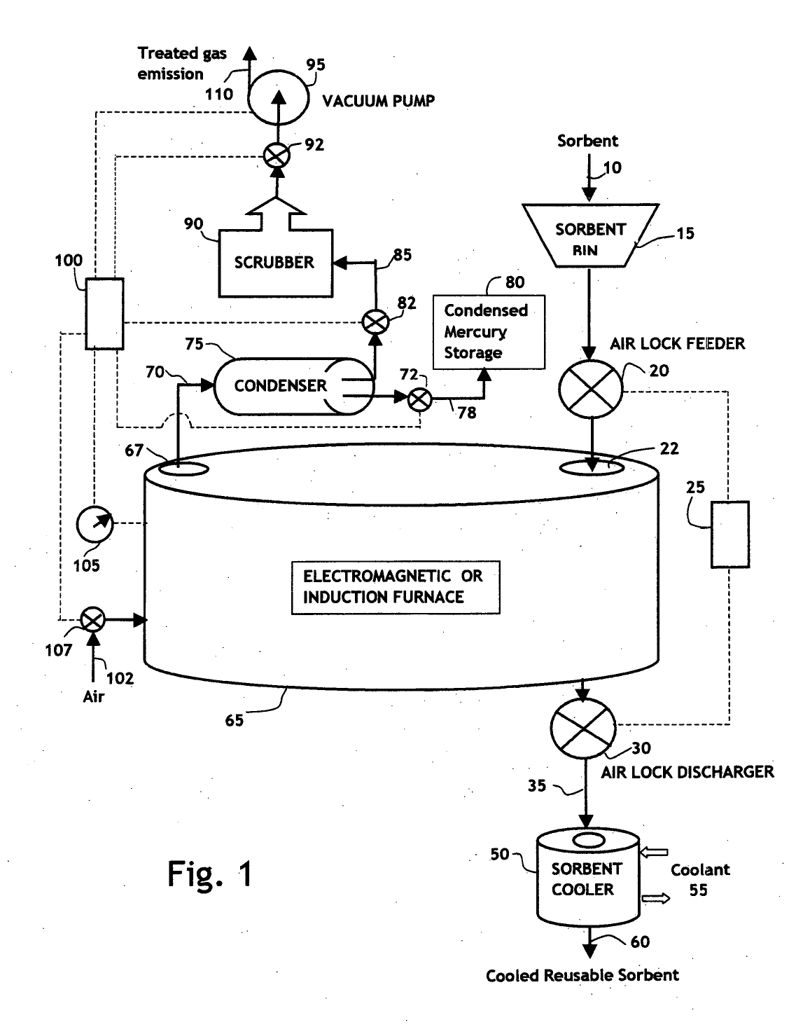

FIG. 1 shows a sorbent recovery system of the present invention. Sorbent that has absorbed components of emission gases from industrial processes can be recovered for reuse by feeding it into an air-tight electromagnetic or induction heat furnace where it is heated to vaporize contaminants. The resulting vapors are released through an exhaust port leading to a condenser where mercury is condensed and retrieved. The remaining uncondensed gases are further treated in a scrubber before being reused or released to the atmosphere.

Referring to FIG. 1, Sorbent 10 collected in sorbent bin 15 is fed at a predetermined rate through an air lock feeder 20 into the entry port 22 of an electromagnetic or induction furnace 65. Inside the furnace 65 is a receiving bed for the sorbent and means to uniformly distribute the sorbent over said bed. The furnace 65 is also equipped with a mechanism to uniformly expose the bed of sorbent to the heat source. Microwave energy is introduced to heat the sorbent to a predetermined temperature. The evaporated components 70 are purged out through an exhaust port 67 aided by a vacuum pump 95 upstream. No purging gas of any kind is added. No air is allowed to leak through air valve 107 except to maintain the lowest negative pressures that can be sustained by the microwave furnace. The purged gas 70 is directed to a condenser 75 where mercury, a major contaminant component, is condensed. The condensed mercury 78 is stored in storage 80 for subsequent reuse or disposal. The uncondensed components 85 are further treated in a scrubber 90 before being released as treated emission gas 110. A controller 100 can be programmed to control and coordinate pressure gauge 105, vacuum pump 95, and valves 72, 82, and 92 to maintain safe and smooth operating conditions. The hot contaminant-depleted sorbent 35 is discharged from the furnace through an air lock discharger 30 and cooled in a sorbent cooler/heat exchanger 50 that uses a coolant 55. The cooled sorbent 60 is released for reuse in plant combustion operations. For continuous operations, a controller 25 can be programmed to coordinate the passage of spent sorbent into the air lock feeder 20 and treated sorbent into the air lock discharger 30.

Referring to FIGS. 2 and 3, an airtight microwave rotary hearth furnace 200 has an internal sorbent bed 202 rotating clockwise. Spent sorbent 10 is fed to the furnace through an airlock feeder 20 and into entry port 205. Entry port 205 consist of a slit-like opening bounded by two facing sides, a sorbent leveling side 207 and side 208. The bottom edge of side 207 is spaced above the floor of the sorbent bed 202 to effect a desired thickness of the sorbent bed to be treated. The bottom edge of side 208 is barely touching the sorbent bed floor 202. A one-way air valve 215 keeps the pressure inside the furnace chamber within the minimum safe negative pressure allowed.

Rotating clockwise at a speed predetermined based on the desired length of microwave exposure or desired temperature, the sorbent bed passes through the microwave furnace where it is heated by microwave 210. The released or gasified contaminants are gently sucked out towards the exhaust opening 220 which leads to a condenser similar to that shown in FIG. 1. It is preferable that the opening 220 be situated towards the end of the heating section of the rotary hearth and where the desired length of microwave exposure or temperature is reached. Another wall 203 has a bottom edge spaced above the sorbent bed floor like side 207. Wall 203 separates the heating section from the next cooling and pre-discharge section. It acts as an additional microwave seal. More microwave seal spikes 240 and 242 arranged in a certain pattern may be installed next to the entry wall and wall 203 respectively for extra protection. A continuous operation may need introduction of air through air valve 215 to offset extremely negative pressures developing inside the furnace.

The cooling and pre-discharge section may have a guide wall 245 with a bottom edge barely touching the bed floor. This wall gradually directs the treated sorbent 35 towards the side opening 235 and into an airlock discharger 30 and cooler 50 for further cooling before exposure to the atmosphere. The side opening 235 is air-tightly connected to the airlock discharger by appropriate microwave seals.

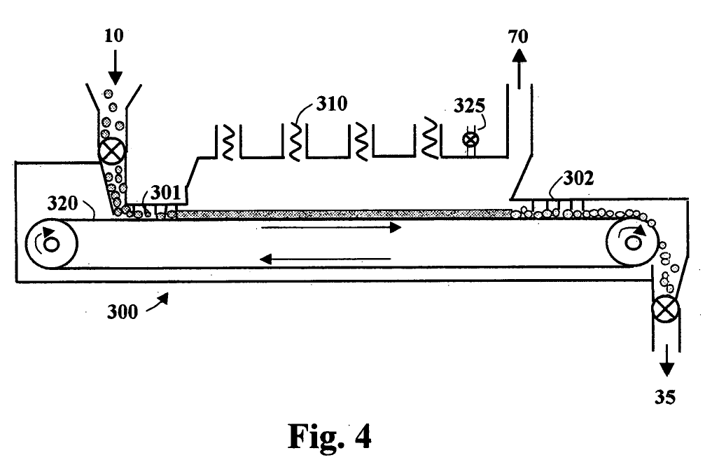

Referring to FIG. 4, a continuous traveling bed furnace 300 is used to treat sorbent 10 by heating using microwave 310. An airlock feeder and discharger are used, microwave seal spikes 301 and 302 at the entrance and discharge sections respectively are added optional protection against microwave leaks. The feeder and discharger can include a spreading element that allows the sorbent to be spread uniformly on the bed similar to entry port 205 shown in FIG. 2 of the rotary hearth previously described. The traveling bed 320 works like a conveyor belt, where the belt is the bed. When the bed is of perforated material as to separate different-sized particles, it may be called a traveling grate. No purge gases are added. An air valve 325 maintains the lowest safe level of negative pressure in the furnace.

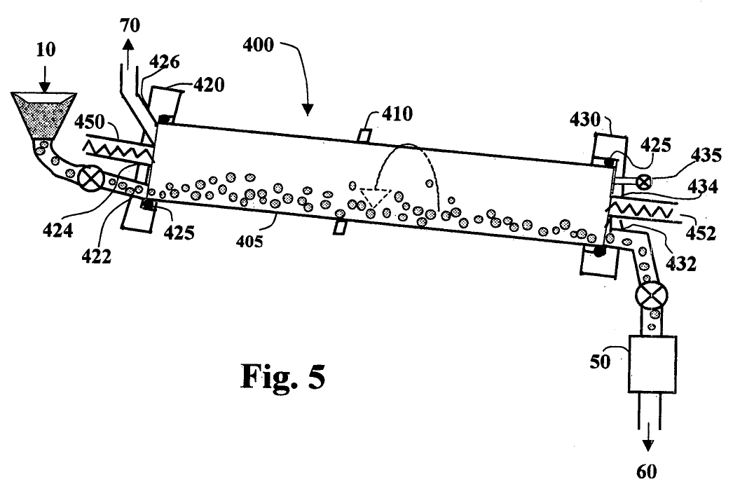

Referring to FIG. 5, a continuous rotating kiln furnace 400 is used to treat sorbent 10 by heating using microwave. A kiln drum 405 is tilted at a predetermined angle and rotated on its longitudinal axis through gears 410. The tilt, rotational speed, microwave intensity, desired internal temperature, and size of the drum are some of the variables that interact to affect the operating conditions. The kiln drum 405 is open on both ends in order to receive and discharge components from and to several openings while it is rotating. The open ends are covered by and rotated within the fixed non-rotating caps 420 and 430 each sealed by a metal rope 425 to prevent air and microwave leaks. The fixed non-rotating cap 420 at the inlet end has openings 422, 424, and 426. Sorbent 10 is introduced into the kiln drum at opening 422. Microwave 450 is introduced through opening 424. Components 70 volatilized in the heating process are released through opening 426. The fixed non-rotating cap 430 at the outlet end has openings 432, 434 and third one for air valve 435. A second microwave source 452 is introduced through opening 434. The treated sorbent is discharged at opening 432 into an airlock discharger for subsequent cooling in a cooler 50. The cooled treated sorbent 60 is disposed of or reused. No additional purge gases are added.

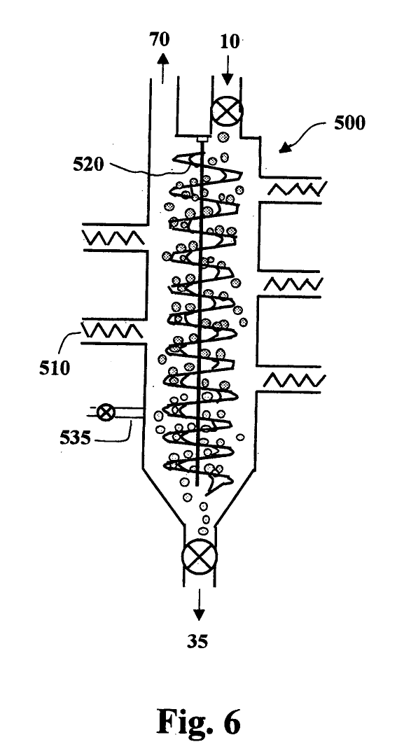

Referring to FIG. 6, a continuous shaft furnace 500 is used to treat sorbent 10 by heating using microwave. Several microwave sources 510 are situated along the length of the shaft. A screw plow 520 preferably made of non-microwave receptive material receives the sorbent 10 from an airlock feeder. The screw plow 520 rotates along its longitudinal axis to gradually transport the sorbent from the top to the bottom, the sorbent being heated by microwave along the way. It is preferable that the plow diameter be close to the inner diameter of the shaft to minimize sorbent falling through fast to the bottom without sufficient heating. The treated sorbent at the bottom is discharged as hot treated sorbent 35 through an airlock discharger. The volatilized components or purged gases 70 are released at the top for further treatment. No additional purge gases are added. There is also an air valve 535 to maintain safe negative pressure in the furnace.

### CONCLUSION, RAMIFICATIONS, AND SCOPE OF INVENTION

Therefore, it has been shown that the present invention presents a solution to the economic impracticality of the use of purging and heating gases to desorb a sorbent of its contaminating components. Several continuous microwave furnace embodiments of the present invention have been shown and described. Some may be modified by one skilled in the art without departing from the spirit, teachings, and scope of the present invention. The example shown in the disclosure is for illustration purposes to show that the concept works and not intended for limiting the scope of the present invention. The application is not only for powdered activated carbon sorbents but for all other physical states of said sorbent and to all sorbents at large. The application is not only for removal of mercury but also for removal of any substance absorbed in a sorbent that can be volatilized by heat. Microwave as stated in the body of the specifications can include electromagnetic induction sources and these sources include all the frequencies, power, and other intrinsic variables known in the art. Continuous furnaces can be arranged to run as batch furnaces. The shaft furnaces may be paddle-driven or screw driven and may be oriented at horizontally or vertically or anywhere in between. Accordingly, the claims and their equivalents set the scope of the present invention.

We claim the following:

1: A method of treating spent sorbent containing a contaminant for reuse in industrial applications comprising:
a) providing an air-tight container or chamber,
b) providing said air-tight chamber with a non-conventional heat source derived from microwave, radio frequency, infrared, induction furnace or the like,
c) providing monitoring means to maintain operating conditions in said chamber,
d) providing transporting means to feed said spent sorbent into said chamber,
e) providing a receiving bed for said spent sorbent in said chamber,
f) providing an exhaust port in said container or chamber for releasing product vapors,
g) providing removal means to discharge said sorbent from said container or chamber,
h) providing a condenser downstream to said exhaust port,
i) feeding said sorbent solely into said container or chamber and onto said bed,
j) heating said sorbent with said heat source to a temperature of at least the boiling point of said contaminant,
k) removing liquid contaminant from the condenser, and
l) removing the sorbent from the heat furnace for reuse,
whereby the heating of the sorbent using non-conventional heat energy and without the addition of combusting gases or other carbon-free material is a very cost effective way to vaporize out undesirable components and render the sorbent fit for reuse.

2: The method of claim 1 further including providing a vacuum means for rapid transporting of vapors through said exhaust port.

3: The method of claim 1 further including providing a scrubber downstream of the condenser for additionally treating uncondensed vapors coming from said condenser.

4: The method of claim 1 further including providing a cooling system for cooling the sorbent removed from the chamber.

5: The method of claim 1 wherein provisions (a) and (b) comprise a microwave oven.

6: The method of claim 1 wherein provisions (a) to (g) include a continuous rotary hearth microwave furnace.

7: The method of claim 1 wherein provisions (a) to (g) include a continuous rotary kiln microwave furnace.

8: The method of claim 1 wherein provisions (a) to (g) include a continuous traveling bed microwave furnace.

9: The method of claim 1 wherein provisions (a) to (g) include a continuous paddle or screw driven microwave shaft furnace.

10: The method of claim 4 wherein said cooling system utilizes a heat exchanger.

11: The method of claim 1 wherein said contaminant is mercury.

12: A method of treating spent sorbent containing a contaminant for reuse in industrial applications comprising:
m) providing a container or chamber
n) providing said container or chamber with a non-conventional heat source derived from microwave, radio frequency, infrared, induction furnace or the like,
o) providing monitoring means to maintain operating conditions in said chamber, wherein said monitoring means include a control valve for entry of atmospheric air,
p) providing transporting means to feed said spent sorbent into said container or chamber,
q) providing an exhaust port in said container or chamber for releasing product vapors,
r) providing removal means to discharge said sorbent from said container or chamber,
s) providing a condenser downstream to said exhaust port,
t) feeding said sorbent into said container or chamber,
u) heating said sorbent with said heat source to a temperature of at least the boiling point of said contaminant,
v) removing liquid contaminant from the condenser, and
w) removing the sorbent from the heat furnace for reuse,
whereby the heating of the sorbent using non-conventional heat energy and with minimal addition of combusting gases is a very cost effective way to vaporize out undesirable components and render the sorbent fit for reuse.

13: The method of claim 12 further including providing a vacuum means for rapid transporting of vapors through said exhaust port.

14: The method of claim 12 further including providing a scrubber downstream of the condenser for additionally treating uncondensed vapors coming from said condenser.

15: The method of claim 12 further including providing a cooling system for cooling the sorbent removed from the chamber.

16: The method of claim 12 wherein provisions (m) and (n) comprise a microwave oven.

17: The method of claim 12 wherein provisions (m) to (r) include a continuous rotary hearth microwave furnace.

18: The method of claim 12 wherein provisions (m) to (r) include a continuous rotary kiln microwave furnace.

19: The method of claim 12 wherein provisions (m) to (r) include a continuous traveling bed microwave furnace.

20: The method of claim 12 wherein provisions (m) to (r) include a continuous paddle or screw driven microwave shaft furnace.

21: The method of claim 15 wherein said cooling system utilizes a heat exchanger.

22: The method of claim 12 wherein said contaminant is mercury.
